(19) United States
(12) Patent Application Publication
(10) Pub. No.: US 2026/0305699 A1
(43) Pub. Date: Oct. 8, 2026

(54) HEATER ASSEMBLY FOR AN AEROSOL-GEENRATING SYSTEM

(71) Applicant: PHILIP MORRIS PRODUCTS S.A., Neuchatel (CH)

(72) Inventors: Bo JIANG, Oberkirch (CH); Baoling LEI, Shenzhen (CN)

(21) Appl. No.: 19/474,831

(22) PCT Filed: Apr. 17, 2023
(86) PCT No.: PCT/CN2023/088693

§ 371 Date: Oct. 13, 2025

(51) Int. Cl. A24F 40/46; A24F 40/10; A24F 40/42; A24F 40/44; A24F 40/70; C22C 5/06

(52) U.S. Cl. CPC A24F 40/46; A24F 40/10; A24F 40/42; A24F 40/44; A24F 40/70; C22C 5/06

(57) ABSTRACT

A heater assembly (100) for an aerosol-generating system (200), the heater assembly (100) comprising: a resistive heating element (102) for vaporising a liquid aerosol-generating substrate; and a porous body (104) for conveying the liquid aerosol-generating substrate to the resistive heating element (102), the porous body (104) having a liquid absorption surface (104a) and a heating surface (104b), the resistive heating element (102) being located on the heating surface (104b) of the porous ceramic body (104), wherein the resistive heating element (102) comprises a silver palladium alloy consisting of 53 weight percent to 73 weight percent silver, 7 weight percent to 23 weight percent palladium, 1 weight percent to 7 weight percent carbon, 3 weight percent to 17 weight percent oxygen, and impurities.

The invention relates to a heater assembly for an aerosol-generating system. The invention also relates to a cartridge comprising the heater assembly and an aerosol-generating system comprising the cartridge.

Aerosol-generating systems that heat a liquid aerosol-generating substrate in order to generate an inhalable aerosol for delivery to a user are known. In particular, handheld electrically operated aerosol-generating systems comprising a replaceable cartridge comprising a liquid storage portion containing a supply of liquid aerosol-generating substrate and an electrically operated heater configured to heat the liquid aerosol-generating substrate to generate an inhalable aerosol are known. Such known handheld electrically operated aerosol-generating systems typically also comprise a reusable aerosol-generating device comprising control circuitry and a power source for supplying power to the electrically operated heater.

The electrically operated heater typically comprises a resistive heating element in the form of a coil of wire that is wound around an elongate wick, which transports liquid aerosol-generating substrate from the liquid storage portion of the cartridge to the coil of wire. In use, an electric current is passed through the coil of wire to heat the liquid aerosol-generating substrate to generate an inhalable aerosol that is drawn into the mouth of a user by way of a mouthpiece.

In other known handheld electrically operated aerosol-generating systems, the electrically operated heater comprises a resistive heating element located on a heating surface of a porous body, which transports liquid aerosol-generating substrate from the liquid storage portion of the cartridge to the resistive heating element.

Handheld electrically operated aerosol-generating systems of the type described above have been found to have a number of drawbacks. One of them is “dry heating” or “dry puff”. To ensure that a satisfactory aerosol is produced, it is preferable to maintain a sufficient supply of liquid aerosol-generating substrate to the heating element during operation to keep the heating element in a wet state. Dry heating arises where an electric current is passed through the heating element when insufficient liquid aerosol-generating substrate is being supplied to the heating element. Dry heating may, for example, occur when the supply of liquid aerosol-generating substrate in the liquid storage portion of the cartridge has been depleted. Dry heating may result in overheating of the heating element. This may lead to thermal decomposition of the liquid aerosol-generating substrate. Thermal decomposition of the liquid aerosol-generating substrate may produce undesirable by-products. Thermal decomposition of the liquid aerosol-generating substrate may result in the production of an unsatisfactory aerosol. Continued operation of an aerosol-generating system when insufficient liquid aerosol-generating substrate is being supplied to the heating element may thereby result in a poor user experience.

In handheld electrically operated aerosol-generating systems of the type described above the resistive heating element is typically formed of an electrically conductive material such as an alloy. For example, the resistive heating element may be formed of an iron alloy, such as an iron silicon alloy.

Chemical interaction between the liquid aerosol-generating substrate and the resistive heating element may produce undesirable by-products. Chemical interaction between the liquid aerosol-generating substrate and the resistive heating element may damage or impair the function of the resistive heating element. This may negatively impact the consistency of the aerosol generated by the aerosol-generating system.

It would be desirable to provide a heater assembly comprising a resistive heating element for vaporising a liquid aerosol-generating substrate that allows for more consistent aerosol generation and delivery to a user compared to known aerosol-generating systems.

The invention relates to a heater assembly for an aerosol-generating system. The heater assembly may comprise a resistive heating element for vaporising a liquid aerosol-generating substrate. The heater assembly may comprise a porous body for conveying the liquid aerosol-generating substrate to the resistive heating element. The porous body may have a liquid absorption surface, The porous body may have a heating surface. The resistive heating element may be located on the heating surface of the porous ceramic body. The resistive heating element may comprise a silver palladium alloy. The silver palladium alloy may comprise 53 weight percent to 73 weight percent silver. The silver palladium alloy may comprise 7 weight percent to 23 weight percent palladium. The silver palladium alloy may comprise 1 weight percent to 7 weight percent carbon. The silver palladium alloy may comprise 3 weight percent to 17 weight percent oxygen. The silver palladium alloy may comprise impurities.

The invention relates to a cartridge for an aerosol-generating system. The cartridge may comprise a heater assembly. The cartridge may comprise a liquid storage portion for holding a liquid aerosol-generating substrate. The heater assembly may comprise a porous body for conveying the liquid aerosol-generating substrate to the resistive heating element. The porous body may have a liquid absorption surface, The porous body may have a heating surface. The resistive heating element may be located on the heating surface of the porous ceramic body. The resistive heating element may comprise a silver palladium alloy. The silver palladium alloy may comprise 53 weight percent to 73 weight percent silver. The silver palladium alloy may comprise 7 weight percent to 23 weight percent palladium. The silver palladium alloy may comprise 1 weight percent to 7 weight percent carbon. The silver palladium alloy may comprise 3 weight percent to 17 weight percent oxygen. The silver palladium alloy may comprise impurities. The liquid storage portion may be located proximate the liquid absorption surface of the porous body of the heater assembly.

The invention relates to an aerosol-generating system. The aerosol-generating system may comprise a cartridge. The aerosol-generating system may comprise an aerosol-generating device. The cartridge may comprise a heater assembly. The cartridge may comprise a liquid storage portion for holding a liquid aerosol-generating substrate. The heater assembly may comprise a porous body for conveying the liquid aerosol-generating substrate to the resistive heating element. The porous body may have a liquid absorption surface, The porous body may have a heating surface. The resistive heating element may be located on the heating surface of the porous ceramic body. The resistive heating element may comprise a silver palladium alloy. The silver palladium alloy may comprise 53 weight percent to 73 weight percent silver. The silver palladium alloy may comprise 7 weight percent to 23 weight percent palladium. The silver palladium alloy may comprise 1 weight percent to 7 weight percent carbon. The silver palladium alloy may comprise 3 weight percent to 17 weight percent oxygen. The silver palladium alloy may comprise impurities. The liquid storage portion may be located proximate the liquid absorption surface of the porous body of the heater assembly. The aerosol-generating device may comprise a power supply for supplying power to the heater assembly of the cartridge. The aerosol-generating device may comprise control circuitry for controlling the supply of power from the power supply to the heater assembly of the cartridge. The cartridge may be removably couplable to the aerosol-generating device.

According to a first aspect of the invention, there is provided a heater assembly for an aerosol-generating system, the heater assembly comprising: a resistive heating element for vaporising a liquid aerosol-generating substrate; and a porous body for conveying the liquid aerosol-generating substrate to the resistive heating element, the porous body having a liquid absorption surface and a heating surface, the resistive heating element being located on the heating surface of the porous ceramic body, wherein the resistive heating element comprises a silver palladium alloy comprising 53 weight percent to 73 weight percent silver, 7 weight percent to 23 weight percent palladium, 1 weight percent to 7 weight percent carbon, and 3 weight percent to 17 weight percent oxygen.

According to the first aspect of the invention, there is provided a heater assembly for an aerosol-generating system, the heater assembly comprising: a resistive heating element for vaporising a liquid aerosol-generating substrate; and a porous body for conveying the liquid aerosol-generating substrate to the resistive heating element, the porous body having a liquid absorption surface and a heating surface, the resistive heating element being located on the heating surface of the porous ceramic body, wherein the resistive heating element comprises a silver palladium alloy comprising 53 weight percent to 73 weight percent silver, 7 weight percent to 23 weight percent palladium, 1 weight percent to 7 weight percent carbon, 3 weight percent to 17 weight percent oxygen, and impurities.

According to the first aspect of the invention, there is provided a heater assembly for an aerosol-generating system, the heater assembly comprising: a resistive heating element for vaporising a liquid aerosol-generating substrate; and a porous body for conveying the liquid aerosol-generating substrate to the resistive heating element, the porous body having a liquid absorption surface and a heating surface, the resistive heating element being located on the heating surface of the porous ceramic body, wherein the resistive heating element comprises a silver palladium alloy consisting of 53 weight percent to 73 weight percent silver, 7 weight percent to 23 weight percent palladium, 1 weight percent to 7 weight percent carbon, 3 weight percent to 17 weight percent oxygen, and impurities.

According to a second aspect of the invention, there is provided a cartridge for an aerosol-generating system, the cartridge comprising: a heater assembly according to the first aspect of the invention; and a liquid storage portion for holding a liquid aerosol-generating substrate, wherein the liquid storage portion is located proximate the liquid absorption surface of the porous body of the heater assembly.

According to a third aspect of the invention, there is provided an aerosol-generating system comprising: a cartridge according to the second aspect of the invention; and an aerosol-generating device comprising a power supply for supplying power to the heater assembly of the cartridge and control circuitry for controlling the supply of power form the power supply to the heater assembly of the cartridge, wherein the cartridge is removably couplable to the aerosol-generating device.

Provision of a heater assembly comprising a resistive heating element located on a heating surface of a porous body, wherein the resistive heating element comprises a silver palladium alloy consisting of 53 weight percent to 73 weight percent silver, 7 weight percent to 23 weight percent palladium, 1 weight percent to 7 weight percent carbon, 3 weight percent to 17 weight percent oxygen, and impurities may reduce or prevent chemical interaction between the resistive heating element and a liquid aerosol-generating substrate. This may advantageously result in more consistent aerosol generation and delivery to a user.

As used herein, the term “heating element” is used to describe a component which transfers heat energy to the liquid aerosol-generating substrate.

As used herein, the term “aerosol-generating substrate” is used to describe a substrate comprising aerosol-generating material that is capable of releasing upon heating volatile compounds that can generate an aerosol.

As used herein, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “porous body” is used to describe a component comprising a plurality of interconnected pores. The porous body is configured to contain liquid within the plurality of pores.

As used herein, the term “heating surface” is used to describe a surface of the porous body on which the resistive heating element is located.

As used herein, the term “located on” is used to describe an arrangement in which the resistive heating element is in direct contact with the heating surface of the porous body and an arrangement in which another component is arranged between the resistive heating element and heating surface of the porous body.

As used herein, the term “liquid absorption surface” is used to describe a surface of the porous body opposed to the heating surface. In use, the liquid absorption surface may be arranged to receive liquid aerosol-generating substrate.

As used herein, the term “longitudinal” is used to describe the direction between the heating surface and the liquid absorption surface of the porous body. In use, liquid aerosol-generating substrate is drawn through the porous body from the liquid absorption surface to the heating surface in the longitudinal direction.

As used herein, the term “transverse” is used to describe the direction perpendicular to the longitudinal direction. Unless otherwise stated, references to the “cross-section” of the heater assembly or a component of the heater assembly refer to the transverse cross-section.

As used herein, the term “aerosol-generating device” is used to describe a device that interacts with an aerosol-generating substrate to generate an aerosol. In particular, the term “aerosol-generating device” is used to describe a device that heats an aerosol-generating substrate to generate an aerosol.

As used herein, the terms “proximal” and “distal” are used to describe the relative positions of components, or portions of components, of cartridges according to the second aspect of the invention and aerosol-generating systems according to the third aspect of the invention.

Cartridges according to the second aspect of the invention comprise a proximal end through which, in use, an aerosol exits the cartridge. Cartridges according to the second aspect of the invention comprise a distal end opposite the proximal end. The proximal end of the cartridge may also be referred to as the mouth end or downstream end. The distal end of the cartridge may also be referred to as the upstream end.

Preferably, the silver palladium alloy comprises 60 weight percent to 70 weight percent silver.

Preferably, the silver palladium alloy comprises 10 weight percent to 20 weight percent palladium.

Preferably, the silver palladium alloy comprises 1 weight percent to 5 weight percent carbon.

Preferably, the silver palladium alloy comprises 5 weight percent to 15 weight percent oxygen.

Preferably, the silver palladium alloy comprises less than 1 weight percent of impurities.

The elemental composition of the silver palladium alloy may be measured by energy dispersive spectroscopy (EDS).

The resistive heating element may have any suitable shape.

The resistive heating element may be a planar resistive heating element.

The resistive heating element may comprise a track. The track may define a path across the heating surface of the porous body. The track may define a curvilinear path across the heating surface of the porous body. The track may define a serpentine path across the heating surface of the porous body.

The resistive heating element may comprise a plurality of tracks or track portions. The plurality of tracks or track portions may be arranged electrically in parallel.

The resistive heating element may have any suitable thickness. As used herein, the term “thickness” is used to describe the maximum dimension of the resistive heating element in the longitudinal direction. That is, the maximum dimension of the resistive heating element in the direction between the heating surface and the liquid absorption surface of the porous body.

The resistive heating element may have a thickness of greater than or equal to 2 micrometres. For example, the resistive heating element may have a thickness of greater than or equal to 5 micrometres, greater than or equal to 10 micrometres, or greater than or equal to 15 micrometres.

The resistive heating element may have a thickness of less than or equal to 100 micrometres. For example, the resistive heating element may have a thickness of less than or equal to 50 micrometres, less than or equal to 30 micrometres, or less than or equal to 25 micrometres.

The resistive heating element may have a thickness of between 2 micrometres and 100 micrometres, 2 micrometres and 50 micrometres, between 2 micrometres and 30 micrometres, or between 2 micrometres and 25 micrometres.

The resistive heating element may have a thickness of between 5 micrometres and 100 micrometres, 5 micrometres and 50 micrometres, between 5 micrometres and 30 micrometres, or between 5 micrometres and 25 micrometres.

The resistive heating element may have a thickness of between 10 micrometres and 100 micrometres, 10 micrometres and 50 micrometres, between 10 micrometres and 30 micrometres, or between 10 micrometres and 25 micrometres.

The resistive heating element may have a thickness of between 15 micrometres and 100 micrometres, 15 micrometres and 50 micrometres, between 15 micrometres and 30 micrometres, or between 15 micrometres and 25 micrometres.

The thickness of the resistive heating element may be substantially constant along the length of the resistive heating element.

The thickness of the resistive heating element may vary along the length of the resistive heating element.

The resistive heating element may have a resistance at 25 degrees Celsius of greater than or equal to 0.8 Ohms, greater than or equal to 0.85 Ohms, or greater than or equal to 0.9 Ohms.

The resistive heating element may have a resistance at 25 degrees Celsius of less than or equal to 1.1 Ohms, less than or equal to 1.05 Ohms, or less than or equal to 1 Ohm.

The resistive heating element may have a resistance at 25 degrees Celsius of between 0.8 Ohms and 1.1 Ohms, between 0.8 Ohms and 1.05 Ohms, or between 0.8 Ohms and 1 Ohm.

The resistive heating element may have a resistance at 25 degrees Celsius of between 0.85 Ohms and 1.1 Ohms, between 0.85 Ohms and 1.05 Ohms, or between 0.85 Ohms and 1 Ohm.

The resistive heating element may have a resistance at 25 degrees Celsius of between 0.9 Ohms and 1.1 Ohms, between 0.9 Ohms and 1.05 Ohms, or between 0.9 Ohms and 1 Ohm. For example, the resistive heating element may have a resistance at 25 degrees Celsius of 0.95 Ohms.

The resistive heating element may have a temperature coefficient of resistance (TCR) of greater than or equal to 250 parts per million per degree Celsius or greater than or equal to 300 parts per million per degree Celsius for a temperature range of 25 degrees Celsius to 300 degrees Celsius.

The resistive heating element may have a temperature coefficient of resistance (TCR) of less than or equal to 450 parts per million per degree Celsius or less than or equal to 400 parts per million per degree Celsius for a temperature range of 25 degrees Celsius to 300 degrees Celsius.

The resistive heating element may have a temperature coefficient of resistance (TCR) of between 250 parts per million per degree Celsius and 450 parts per million per degree Celsius or between 250 parts per million per degree Celsius and 400 parts per million per degree Celsius for a temperature range of 25 degrees Celsius to 300 degrees Celsius.

The resistive heating element may have a temperature coefficient of resistance (TCR) of between 300 parts per million per degree Celsius and 450 parts per million per degree Celsius or between 300 parts per million per degree Celsius and 400 parts per million per degree Celsius for a temperature range of 25 degrees Celsius to 300 degrees Celsius.

For example, the resistive heating element may have a temperature coefficient of resistance (TCR) of 350 parts per million per degree Celsius for a temperature range of 25 degrees Celsius to 300 degrees Celsius.

The resistive heating element may be pre-formed as a solid component and then affixed to or otherwise arranged on the heating surface of the porous body.

The resistive heating element may be deposited on the heating surface of the porous body. As used herein, the term “deposited” is used to describe application of a layer or coating by a physical or chemical process, for example in the form of a liquid, plasma or vapour which subsequently condenses or aggregates to form the resistive heating element.

The resistive heating element may be deposited on the heating surface of the porous body by any suitable process.

The resistive heating element may be deposited on the heating surface of the porous body by a printing process. For example, resistive heating element may be deposited on the heating surface of the porous body by aerosol-jet printing, inkjet printing, or screen printing.

The resistive heating element may be deposited on the heating surface of the porous body by a vacuum deposition process.

The resistive heating element may be deposited on the heating surface of the porous body by physical vapor deposition. For example, the resistive heating element may be deposited on the heating surface of the porous body by evaporation or sputtering.

The resistive heating element may be deposited on the heating surface of the porous body by chemical vapor deposition.

The resistive heating element may be deposited directly on the heating surface of the porous body. In such embodiments, the resistive heating element is in direct contact with the heating surface of the porous body.

The heater assembly may further comprise one or more electrical contacts connected to the resistive heating element. The electrical contacts may be configured to be connected to control circuitry for controlling the supply of electrical power to the resistive heating element.

The one or more electrical contacts may be located on the heating surface of the porous body.

The one or more electrical contacts may be deposited directly onto the heating surface of the porous body.

The one or more electrical contacts may be formed from any suitable material. Suitable materials may include, but are not limited to, copper, gold, silver, and zinc.

The one or more electrical contacts may be more electrically conductive than the resistive heating element.

The heater assembly may comprise a pair of electrical contacts. The pair of electrical contacts may be located on opposite sides of the heating surface of the porous body. The resistive heating element may extend between the pair of electrical contacts.

The resistive heating element may be in direct contact with the heating surface of the porous body.

The resistive heating element may be bonded to the heating surface of the porous body. The heater assembly may comprise a thermally insulating layer disposed between the resistive heating element and the heating surface of the porous body. The thermally insulating layer may have a lower thermal conductivity than the porous body. The thermally insulating layer may be configured to reduce heat transfer from the resistive heating element to the porous body. The thermally insulating material may have a higher porosity than the porous body.

The thermally insulating layer may advantageously completely separate the resistive heating element and the heating surface of the porous body such that there is no direct contact between the resistive heating element and the porous body.

The porous body comprises a plurality of interconnected pores. The interconnected pores provide a fluid pathway for liquid aerosol-generating substrate through the porous body, from the liquid absorption surface to the heating surface.

In use, liquid aerosol-generating substrate is drawn through the porous body from the liquid absorption surface to the heating surface in the longitudinal direction via the plurality of interconnected pores. Liquid aerosol-generating substrate may be conveyed through the porous by capillary action.

The porous body may have any suitable porosity. The porosity of the porous body may be measured by mercury porosimetry in accordance with ISO 15901-2:2022.

The porosity of the porous body may be greater than or equal to 30 percent, greater than or equal to 40 percent, or greater than or equal to 50 percent.

The porosity of the porous body may be less than or equal to 80 percent, less than or equal to 70 percent, or less than or equal to 60 percent.

The porosity of the porous body may be between 30 percent and 80 percent, between 30 percent and 70 percent, or between 30 percent and 60 percent.

The porosity of the porous body may be between 40 percent and 80 percent, between 40 percent and 70 percent, or between 40 percent and 60 percent.

The porosity of the porous body may be between 50 percent and 80 percent, between 50 percent and 70 percent, or between 50 percent and 60 percent.

For example, the porous body may be a porous ceramic body having a porosity of between 50 percent and 60 percent.

The porous body may have any median pore size. As used herein, the term “median pore size” refers to the “D50 size”. The D50 size is the pore size which splits the distribution in half, where half of the pores are larger than the D50 size and half of the pores are smaller than the D50 size. The pore size distribution of the porous body may be measured by mercury porosimetry in accordance with ISO 15901-2:2022.

The porous body may have a median pore size of greater than or equal to 5 micrometres, greater than or equal to 10 micrometres, or greater than or equal to 15 micrometres.

The porous body may have a median pore size of less than or equal to 35 micrometres, less than or equal to 30 micrometres, or less than or equal to 25 micrometres.

The porous body may have a median pore size of between 5 micrometres and 35 micrometres, between 5 micrometres and 30 micrometres, or between 5 micrometres and 25 micrometres.

The porous body may have a median pore size of between 10 micrometres and 35 micrometres, between 10 micrometres and 30 micrometres, or between 10 micrometres and 25 micrometres.

The porous body may have a median pore size of between 15 micrometres and 35 micrometres, between 15 micrometres and 30 micrometres, or between 15 micrometres and 25 micrometres.

For example, the porous body may be a porous ceramic body having a median pore size of between 19 micrometres and 22 micrometres.

The porous body may have any suitable shape.

The porous body may have any suitable length. As used herein, the term “length” is used to describe the maximum dimension of the porous body in the longitudinal direction. That is, the maximum dimension of the porous body in the direction between the heating surface and the liquid absorption surface of the porous body.

The porous body may have a length of greater than or equal to 0.5 millimetres. For example, the porous body may have a length of greater than or equal to 1 millimetre, greater than or equal to 2 millimetres, greater than or equal to 3 millimetres, greater than or equal to 4 millimetres, or greater than or equal to 5 millimetres.

The porous body may have a length of less than or equal to 20 millimetres. For example, the porous body may have a length of less than or equal to 10 millimetres, less than or equal to 9 millimetres, less than or equal to 8 millimetres, less than or equal to 7 millimetres, or less than or equal to 6 millimetres.

The porous body may have a length of between 0.5 millimetres and 20 millimetres. For example, the porous body may have a length of between 0.5 millimetres and 10 millimetres, between 0.5 millimetres and 9 millimetres, between 0.5 millimetres and 8 millimetres, between 0.5 millimetres and 7 millimetres, or between 0.5 millimetres and 6 millimetres.

The porous body may have a length of between 1 millimetre and 20 millimetres. For example, the porous body may have a length of between 1 millimetre and 10 millimetres, between 1 millimetre and 9 millimetres, between 1 millimetre and 8 millimetres, between 1 millimetre and 7 millimetres, or between 01 millimetre and 6 millimetres.

The porous body may have a length of between 2 millimetres and 20 millimetres. For example, the porous body may have a length of between 2 millimetres and 10 millimetres, between 2 millimetres and 9 millimetres, between 2 millimetres and 8 millimetres, between 2 millimetres and 7 millimetres, or between 2 millimetres and 6 millimetres.

The porous body may have a length of between 3 millimetres and 20 millimetres. For example, the porous body may have a length of between 3 millimetres and 10 millimetres, between 3 millimetres and 9 millimetres, between 3 millimetres and 8 millimetres, between 3 millimetres and 7 millimetres, or between 3 millimetres and 6 millimetres.

The porous body may have a length of between 4 millimetres and 20 millimetres. For example, the porous body may have a length of between 4 millimetres and 10 millimetres, between 4 millimetres and 9 millimetres, between 4 millimetres and 8 millimetres, between 4 millimetres and 7 millimetres, or between 4 millimetres and 6 millimetres.

The porous body may have a length of between 5 millimetres and 20 millimetres. For example, the porous body may have a length of between 5 millimetres and 10 millimetres, between 5 millimetres and 9 millimetres, between 5 millimetres and 8 millimetres, between 5 millimetres and 7 millimetres, or between 5 millimetres and 6 millimetres.

For example, the porous body may have a length of 5 millimetres.

A liquid impermeable coating may be provided on a longitudinal surface of the porous body extending between the liquid absorption surface of the porous body and the heating surface of the porous body.

The porous body may have any suitable cross-sectional shape. For example, the cross-sectional shape of the porous body may be circular, semi-circular, elliptical, triangular, square, rectangular or trapezoidal.

The cross-section of the porous body may be substantially constant along the length of the porous body. The surface area of the liquid absorption surface of the porous body may be substantially the same as the surface area of the heating surface of the porous body.

For example, the porous body may be substantially cylindrical and the liquid absorption surface of the porous body and the heating surface of the porous body may both be substantially circular or the porous body may be substantially cuboid and the liquid absorption surface of the porous body and the heating surface of the porous body may both be substantially square.

The cross-section of the porous body may vary along the length of the porous body. The surface area of the liquid absorption surface of the porous body may be different to the surface area of the heating surface of the porous body. The surface area of the liquid absorption surface of the porous body may be greater than the surface area of the heating surface of the porous body.

The porous body may be substantially incompressible.

The porous body may comprise any suitable material.

The porous body may comprise a heat resistant material.

The porous body may comprise a material that does not chemically interact with the liquid aerosol-generating substrate.

The porous body may be a porous ceramic body. As used herein, the term “porous ceramic body” is used to describe a porous body comprising a ceramic.

The porous ceramic body may comprise a sintered ceramic.

The porous ceramic body may comprise any suitable ceramic.

The porous ceramic body may comprise one or more of a ceramic carbide, a ceramic nitride, a ceramic oxide, and a ceramic silicate.

Examples of suitable ceramics include, but are not limited to, aluminium oxides, aluminosilicates, calcium phosphates, calcium silicates, silicon carbides, silicon nitrides, silicon oxides, and zirconium oxides.

The porous ceramic body may comprise one or more of alumina (Al₂O₃), an aluminosilicate, a boride, silica (SiO₂), a silicide, silicon carbide, silicon nitride, and zirconia (ZrO₂).

The porous ceramic body may comprise one or more of alumina (Al₂O₃), silica (SiO₂), and zirconia (ZrO₂).

The porous ceramic body may comprise silica (SiO₂).

The porous ceramic body may comprise silica (SiO₂) and alumina (Al₂O₃).

The porous ceramic body may comprise silica (SiO₂), alumina (Al₂O₃), and calcium oxide (CaO).

According to a second aspect of the invention, there is provided a cartridge for an aerosol-generating system, the cartridge comprising: a heater assembly according to the first aspect of the invention; and a liquid storage portion for holding a liquid aerosol-generating substrate, wherein the liquid storage portion is located proximate the liquid absorption surface of the porous body of the heater assembly.

The cartridge may have any suitable shape. For example, the cartridge may be substantially cylindrical.

The cartridge may have any suitable cross-sectional shape. For example, the cross-sectional shape of the cartridge may be circular, semi-circular, elliptical, triangular, square, rectangular or trapezoidal.

The cartridge may have any suitable size.

The cartridge may comprise a cartridge housing.

The cartridge housing may be formed from any suitable material or combination of materials. Suitable materials include, but are not limited to, fluorinated ethylene propylene (FEP), polyether ether ketone (PEEK), polyethylene (PE), high-density polyethylene (HDPE), polyethylene terephthalate (PET), polyoxymethylene (POM), polypropylene (PP), polytetrafluoroethylene (PTFE), and copolymers such as Tritan™, which is made from three monomers: dimethyl terephthalate (DMT), cyclohexanedimethanol (CHDM), and 2,2,4,4-tetramethyl-1,3-cyclobutanediol (CBDO).

The cartridge housing may be formed from a durable material. The cartridge housing may be formed from a liquid impermeable material. The cartridge housing may be formed form a mouldable plastic material.

The cartridge housing may be formed by any suitable method. Suitable methods include, but are not limited to, blistering, blow forming, extrusion, deep drawing, and injection moulding.

The cartridge may comprise a mouthpiece at the proximal end of the cartridge.

The cartridge may comprise a connection end at the distal end of the cartridge. The connection end may be configured to couple the cartridge to an aerosol-generating device.

The cartridge may comprise one or more air inlets through which, in use, air may be drawn into the cartridge. The one or more air inlets may be provided in the cartridge housing.

The cartridge may comprise one or more aerosol outlets through which, in use, aerosol may be drawn out of the cartridge. Where the cartridge comprises a mouthpiece, the mouthpiece may comprise one or more aerosol outlets through which, in use, aerosol may be drawn out of the mouthpiece. The one or more aerosol outlets may be provided in the cartridge housing.

The one or more air inlets may be in fluid communication with the one or more aerosol outlets to define an airflow pathway through the cartridge.

The cartridge may comprise an enclosed airflow passage extending from the one or more air inlets to the one or more aerosol outlets. The enclosed airflow passage may extend from the one or more air inlets, past the heater assembly, to the one or more aerosol outlets. The enclosed airflow passage may pass around an external surface of the liquid storage portion. The enclosed airflow passage may pass through the liquid storage portion. For example, the liquid storage portion may have an annular cross-section defining an internal passage, and the enclosed airflow passage may extend through the internal passage.

The cartridge may comprise a first airflow pathway that extends from the one or more air inlets towards the resistive heater assembly in a first direction. The cartridge may comprise a second airflow pathway that extends past the resistive heating element. The cartridge may comprise a third airflow pathway that extends from the resistive heater assembly to the one or more aerosol outlets in a second direction. The second direction may be opposite to the first direction. The second airflow pathway may provide a fluid connection between the first airflow pathway and the third airflow pathway.

The cartridge may be configured such that air flow past the heater assembly entrains vaporised aerosol-generating substrate.

The cartridge housing of the cartridge may define the liquid storage portion.

The cartridge housing and the liquid storage portion may be integrally formed.

The liquid storage portion may be formed separately from the cartridge housing and arranged within the cartridge housing.

The liquid storage portion is located proximate the liquid absorption surface of the porous body of the heater assembly.

The liquid storage portion may be referred to as a reservoir.

The liquid storage portion may contain a liquid aerosol-generating substrate.

The liquid aerosol-generating substrate may comprise nicotine.

As used herein, the term “nicotine” is used to describe nicotine, a nicotine base or a nicotine salt.

The liquid aerosol-generating substrate may comprise natural nicotine.

The liquid aerosol-generating substrate may comprise synthetic nicotine.

The liquid aerosol-generating substrate may comprise an aerosol former.

The liquid aerosol-generating substrate may comprise nicotine and an aerosol former.

The aerosol former may be any suitable known compound or mixture of compounds that, in use, facilitates formation of a dense and stable aerosol. The aerosol former may be substantially resistant to thermal degradation at temperatures typically reached during use of an aerosol-generating system comprising the cartridge.

Examples of suitable aerosol formers include, but are not limited to: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Advantageously, the aerosol former may comprise one or more polyhydric alcohols.

More advantageously, the aerosol former comprises one or more polyhydric alcohols selected from the group consisting of propylene glycol, triethylene glycol, 1,3-butanediol and glycerine.

The aerosol former may comprise one or both of glycerine and propylene glycol. The aerosol former may consist of glycerine. The aerosol former may consist of propylene glycol. The aerosol former may consist of a combination of glycerine and propylene glycol.

The liquid aerosol-generating substrate may comprise water.

The liquid aerosol-generating substrate may comprise one or more flavourants.

The liquid aerosol-generating substrate may comprise one or more natural flavourants.

The liquid aerosol-generating substrate may comprise one or more synthetic flavourants.

The liquid aerosol-generating substrate may have a nicotine content of greater than or equal to 0.5 percent by weight, greater than or equal to 1 percent by weight, or greater than or equal to 1.5 percent by weight.

The liquid aerosol-generating substrate may have a nicotine content of less than or equal to 10 percent by weight, less than or equal to 5 percent by weight, or less than or equal to 3 percent by weight.

The liquid aerosol-generating substrate may have a nicotine content of between 0.5 percent by weight and 10 percent by weight. For example, the liquid aerosol-generating substrate may have a nicotine content of between 0.5 percent by weight and 5 percent by weight or between 0.5 percent by weight and 3 percent by weight.

The liquid aerosol-generating substrate may have a nicotine content of between 1 percent by weight and 10 percent by weight. For example, the liquid aerosol-generating substrate may have a nicotine content of between 1 percent by weight and 5 percent by weight or between 1 percent by weight and 3 percent by weight.

The liquid aerosol-generating substrate may have a nicotine content of between 1.5 percent by weight and 10 percent by weight. For example, the liquid aerosol-generating substrate may have a nicotine content of between 1.5 percent by weight and 5 percent by weight or between 1.5 percent by weight and 3 percent by weight.

For example, the liquid aerosol-generating substrate may have a nicotine content of 2 percent by weight.

The cartridge may be designed to be disposed of once the liquid aerosol-generating substrate contained in the liquid storage portion is depleted.

The cartridge may be designed to be refillable.

According to the third aspect of the invention, there is provided an aerosol-generating system comprising: a cartridge according to the second aspect of the invention; and an aerosol-generating device comprising a power supply for supplying power to the heater assembly of the cartridge and control circuitry for controlling the supply of power form the power supply to the heater assembly of the cartridge, wherein the cartridge is removably couplable to the aerosol-generating device.

The aerosol-generating system may comprise one or more air inlets. The one or more air inlets may be arranged at an interface between the cartridge and the aerosol-generating device.

The aerosol-generating system may comprise an enclosed airflow passage extending from the one or more air inlets to one or more aerosol outlets. The enclosed airflow passage may extend from the one or more air inlets, past the heater assembly, to the one or more aerosol outlets.

The aerosol-generating system may comprise a first airflow pathway that extends from the one or more air inlets towards the heater assembly in a first direction. The aerosol-generating system may comprise a second airflow pathway that extends past the resistive heating element. The aerosol-generating system may comprise a third airflow pathway that extends from the heater assembly to the one or more aerosol outlets in a second direction. The second direction may be opposite to the first direction. The second airflow pathway may provide a fluid connection between the first airflow pathway and the third airflow pathway.

The aerosol-generating system may be configured such that air flow past the heater assembly entrains liquid aerosol-generating substrate vaporised by the resistive heating element.

The aerosol-generating device may comprise a device housing.

The device housing may be formed from any suitable material or combination of materials. Suitable materials include, but are not limited to, alloys, metals, and plastics such as, for example, polyether ether ketone (PEEK), polyethylene (PE), high density polyethylene (HDPE), and polypropylene (PP).

The device housing may define a cavity for receiving at least a portion of the cartridge.

The aerosol-generating device may have a connection end configured to removably connect the aerosol-generating device to the cartridge.

The power supply may be any suitable power supply. The power supply may be a DC power supply. The power supply may be a battery. The power supply may be a lithium based battery. For example, the power supply may be a lithium-ion battery, such as a lithium cobalt oxide (CBO) battery, a lithium iron phosphate (LFP) battery, or a lithium-titanate (LTO) battery, or a lithium-polymer battery. The power supply may be a nickel based battery. For example, the battery may be a nickel-metal hydride battery (Ni—MH) or a nickel-cadmium (Ni—Cd) battery. The power supply may be another form of charge storage device such as a capacitor. The power supply may be rechargeable. The power supply may be configured for many cycles of charge and discharge. The power supply may have a capacity that allows for the storage of enough energy for one or more user experiences of the aerosol-generating system. For example, the power supply may have sufficient capacity to allow for the continuous generation of aerosol for a period of around six minutes, corresponding to the typical time taken to smoke a conventional cigarette, or for a period that is a multiple of six minutes. The power supply may have sufficient capacity to allow for a predetermined number of puffs or discrete activations of the aerosol-generating system.

The aerosol-generating device may comprise an electrical connector configured to connect the aerosol-generating device to an electrical connector of an external power supply, for charging the power supply of the aerosol-generating device.

The control circuitry may be configured to supply power to the resistive heating element continuously following activation of the aerosol-generating device. The control circuitry may be configured to supply power to the resistive heating element intermittently following activation of the aerosol-generating device, such as on a puff-by-puff basis. The power may be supplied to the resistive heating element in the form of pulses of electrical current, for example, by means of pulse width modulation (PWM).

The control circuitry may comprise any suitable electronic components. The control circuitry may comprise a memory. The control circuitry may comprise a microprocessor. The microprocessor may be a programmable microprocessor, a microcontroller, or an application specific integrated chip (ASIC) or other electronic circuitry capable of providing control.

The control circuitry may comprise other electronic components. For example, the control circuitry may comprise one or more of sensors, switches, and display elements.

The aerosol-generating system may comprise a puff detector. The puff detector may be configured to detect when a user draws on the aerosol-generating system. The puff detector may be any suitable sensor that is capable of detecting when a user draws on the aerosol-generating device. For example, the puff detector may be an airflow sensor. The control circuitry may be configured to supply power to the resistive heating element when the puff detector detects a user drawing on the aerosol-generating system.

The invention is defined in the claims. However, below there is provided a non-exhaustive list of non-limiting examples. Any one or more of the features of these examples may be combined with any one or more features of another example, embodiment, or aspect described herein.

Example Ex1: A heater assembly for an aerosol-generating system, the heater assembly comprising: a resistive heating element for vaporising a liquid aerosol-generating substrate; and a porous body for conveying the liquid aerosol-generating substrate to the resistive heating element, the porous body having a liquid absorption surface and a heating surface, the resistive heating element being located on the heating surface of the porous ceramic body, wherein the resistive heating element comprises a silver palladium alloy comprising 53 weight percent to 73 weight percent silver, 7 weight percent to 23 weight percent palladium, 1 weight percent to 7 weight percent carbon, and 3 weight percent to 17 weight percent oxygen.

Example Ex2: A heater assembly according to example Ex1 wherein the silver palladium alloy comprises impurities.

Example Ex3: A heater assembly according to example Ex1 or example Ex2 wherein the silver palladium alloy consists of 53 weight percent to 73 weight percent silver, 7 weight percent to 23 weight percent palladium, 1 weight percent to 7 weight percent carbon, 3 weight percent to 17 weight percent oxygen, and impurities.

Example Ex4: A heater assembly according to any one of examples Ex1 to Ex3 wherein the silver palladium alloy comprises 60 weight percent to 70 weight percent silver.

Example Ex5: A heater assembly according to any one of examples Ex1 to Ex4 wherein the silver palladium alloy comprises 10 weight percent to 20 weight percent palladium.

Example Ex6: A heater assembly according to any one of examples Ex1 to Ex5 wherein the silver palladium alloy comprises 1 weight percent to 5 weight percent carbon.

Example Ex7: A heater assembly according to any one of examples Ex1 to Ex6 wherein the silver palladium alloy comprises 5 weight percent to 15 weight percent oxygen.

Example Ex8: A heater assembly according to any one of examples Ex1 to Ex7 wherein the silver palladium alloy consists of 60 weight percent to 70 weight percent silver, 10 weight percent to 20 weight percent palladium, 1 weight percent to 5 weight percent carbon, 5 weight percent to 15 weight percent oxygen, and impurities.

Example Ex9: A heater assembly according to any one of examples Ex2 to Ex8 wherein the silver palladium alloy comprises less than 1 weight percent of impurities.

Example Ex10: A heater assembly according to any one of examples Ex1 to Ex9 wherein the resistive heating element has a resistance at 25 degrees Celsius of greater than or equal to 0.8 Ohms.

Example Ex11: A heater assembly according to any one of examples Ex1 to Ex10 wherein the resistive heating element has a resistance at 25 degrees Celsius of greater than or equal to 0.85 Ohms.

Example Ex12: A heater assembly according to any one of examples Ex1 to Ex11 wherein the resistive heating element has a resistance at 25 degrees Celsius of greater than or equal to 0.9 Ohms.

Example Ex13: A heater assembly according to any one of examples Ex1 to Ex12 wherein the resistive heating element has a resistance at 25 degrees Celsius of less than or equal to 1.1 Ohms.

Example Ex14: A heater assembly according to any one of examples Ex1 to Ex13 wherein the resistive heating element has a resistance at 25 degrees Celsius of less than or equal to 1.1 Ohms.

Example Ex15: A heater assembly according to any one of examples Ex1 to Ex14 wherein the resistive heating element has a resistance at 25 degrees Celsius of less than or equal to 1.05 Ohms.

Example Ex16: A heater assembly according to any one of examples Ex1 to Ex15 wherein the resistive heating element has a resistance at 25 degrees Celsius of less than or equal to 1 Ohm.

Example Ex17: A heater assembly according to any one of examples Ex1 to Ex16 wherein the resistive heating element has a temperature coefficient of resistance (TCR) of greater than or equal to 250 parts per million per degree Celsius.

Example Ex18: A heater assembly according to any one of examples Ex1 to Ex17 wherein the resistive heating element has a temperature coefficient of resistance (TCR) of greater than or equal to 300 parts per million per degree Celsius.

Example Ex19: A heater assembly according to any one of examples Ex1 to Ex18 wherein the resistive heating element has a temperature coefficient of resistance (TCR) of less than or equal to 450 parts per million per degree Celsius.

Example Ex20: A heater assembly according to any one of examples Ex1 to Ex19 wherein the resistive heating element has a temperature coefficient of resistance (TCR) of less than or equal to 400 parts per million per degree Celsius.

Example Ex21: A heater assembly according to any one of examples Ex1 to Ex20 wherein the resistive heating element has a thickness of greater than or equal to 2 micrometres.

Example Ex22: A heater assembly according to any one of examples Ex1 to Ex21 wherein the resistive heating element has a thickness of greater than or equal to 5 micrometres.

Example Ex23: A heater assembly according to any one of examples Ex1 to Ex22 wherein the resistive heating element has a thickness of greater than or equal to 10 micrometres.

Example Ex24: A heater assembly according to any one of examples Ex1 to Ex23 wherein the resistive heating element has a thickness of greater than or equal to 15 micrometres.

Example Ex25: A heater assembly according to any one of examples Ex1 to Ex24 wherein the resistive heating element has a thickness of less than or equal to 100 micrometres.

Example Ex26: A heater assembly according to any one of examples Ex1 to Ex25 wherein the resistive heating element has a thickness of less than or equal to 50 micrometres.

Example Ex27: A heater assembly according to any one of examples Ex1 to Ex26 wherein the resistive heating element has a thickness of less than or equal to 30 micrometres.

Example Ex28: A heater assembly according to any one of examples Ex1 to Ex27 wherein the resistive heating element has a thickness of less than or equal to 25 micrometres.

Example Ex29: A heater assembly according to any one of examples Ex1 to Ex28 wherein the resistive heating element deposited on the heating surface of the porous body by a vacuum deposition process.

Example Ex30: A heater assembly according to any one of examples Ex1 to Ex29 wherein the resistive heating element deposited on the heating surface of the porous body by physical vapor deposition.

Example Ex31: A heater assembly according to any one of examples Ex1 to Ex29 wherein the resistive heating element deposited on the heating surface of the porous body by chemical vapor deposition.

Example Ex32: A heater assembly according to any one of examples Ex1 to Ex31 wherein the resistive heating element is a planar resistive heating element.

Example Ex33: A heater assembly according to any one of examples Ex1 to Ex32 wherein the resistive heating element comprises a track.

Example Ex34: A heater assembly according to example Ex33 wherein the track defines a path across the heating surface of the porous body.

Example Ex35: A heater assembly according to example Ex34 wherein the track defines a curvilinear path across the heating surface of the porous body.

Example Ex36: A heater assembly according to example Ex34 wherein the track defines a serpentine path across the heating surface of the porous body.

Example Ex37: A heater assembly according to any one of examples Ex1 to Ex36 wherein the porous body has a porosity of greater than or equal to 30 percent.

Example Ex38: A heater assembly according to any one of examples Ex1 to Ex37 wherein the porous body has a porosity of greater than or equal to 40 percent.

Example Ex39: A heater assembly according to any one of examples Ex1 to Ex38 wherein the porous body has a porosity of greater than or equal to 50 percent.

Example Ex40: A heater assembly according to any one of examples Ex1 to Ex39 wherein the porous body has a porosity of less than or equal to 80 percent.

Example Ex41: A heater assembly according to any one of examples Ex1 to Ex40 wherein the porous body has a porosity of less than or equal to 70 percent.

Example Ex42: A heater assembly according to any one of examples Ex1 to Ex41 wherein the porous body has a porosity of less than or equal to 60 percent.

Example Ex43: A heater assembly according to any one of examples Ex1 to Ex42 wherein the porous body has a median pore size of greater than or equal to 5 micrometres.

Example Ex44: A heater assembly according to any one of examples Ex1 to Ex43 wherein the porous body has a median pore size of greater than or equal to 10 micrometres.

Example Ex45: A heater assembly according to any one of examples Ex1 to Ex44 wherein the porous body has a median pore size of greater than or equal to 15 micrometres.

Example Ex46: A heater assembly according to any one of examples Ex1 to Ex45 wherein the porous body has a median pore size of less than or equal to 35 micrometres.

Example Ex47: A heater assembly according to any one of examples Ex1 to Ex46 wherein the porous body has a median pore size of less than or equal to 30 micrometres.

Example Ex48: A heater assembly according to any one of examples Ex1 to Ex47 wherein the porous body has a median pore size of less than or equal to 25 micrometres.

Example Ex49: A heater assembly according to any one of examples Ex1 to Ex48 wherein the porous body is a porous ceramic body.

Example Ex50: A heater assembly according to example Ex49 wherein the porous body comprises a sintered ceramic.

Example Ex51: A heater assembly according to example Ex49 or example Ex50 wherein the porous body comprises one or more of a ceramic carbide, a ceramic nitride, a ceramic oxide, and a ceramic silicate.

Example Ex52: A heater assembly according to any one of examples Ex1 to Ex51 wherein the porous body comprises one or more of alumina, an aluminosilicate, a boride, silica, a silicide, silicon carbide, silicon nitride, and zirconia.

Example Ex53: A heater assembly according to any one of examples Ex1 to Ex52 wherein the porous body comprises silica.

Example Ex54: A heater assembly according to any one of examples Ex1 to Ex53 wherein the porous body comprises silica and alumina.

Example Ex55: A heater assembly according to any one of examples Ex1 to Ex54 wherein the porous body comprises silica, alumina, and calcium oxide.

Example Ex56: A cartridge for an aerosol-generating system, the cartridge comprising:
a heater assembly according to any one of examples Ex1 to Ex55; and
a liquid storage portion for holding a liquid aerosol-generating substrate,
wherein the liquid storage portion is located proximate the liquid absorption surface of the porous body of the heater assembly.

Example Ex57: A cartridge according to example Ex56 wherein the liquid storage portion contains a liquid aerosol-generating substrate.

Example Ex58: A cartridge according to example Ex57 wherein the liquid aerosol-generating substrate comprises nicotine.

Example Ex59: A cartridge according to example Ex57 or example Ex58 wherein the liquid aerosol-generating substrate comprises an aerosol former.

Example Ex60: An aerosol-generating system comprising:
a cartridge according to any one of examples Ex56 to Ex58; and
an aerosol-generating device comprising a power supply for supplying power to the heater assembly of the cartridge and control circuitry for controlling the supply of power from the power supply to the heater assembly of the cartridge,
wherein the cartridge is removably couplable to the aerosol-generating device.

The invention will now be further described, by way of example only, with reference to the accompanying drawings in which:

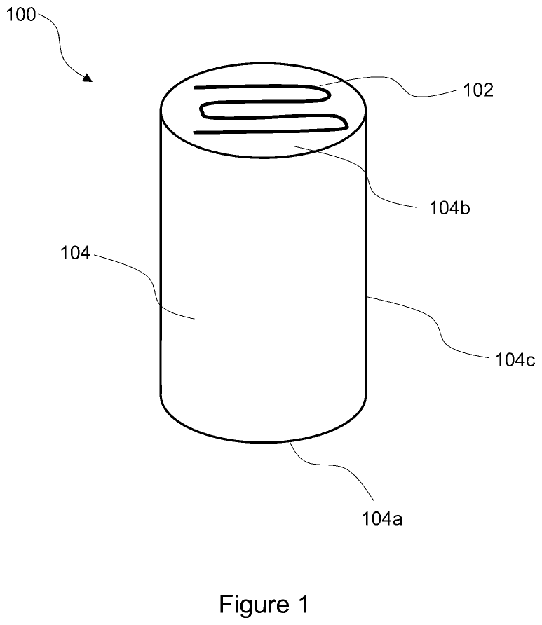

FIG. 1 shows a schematic perspective view of a heater assembly according to an embodiment of the first aspect of the invention; and

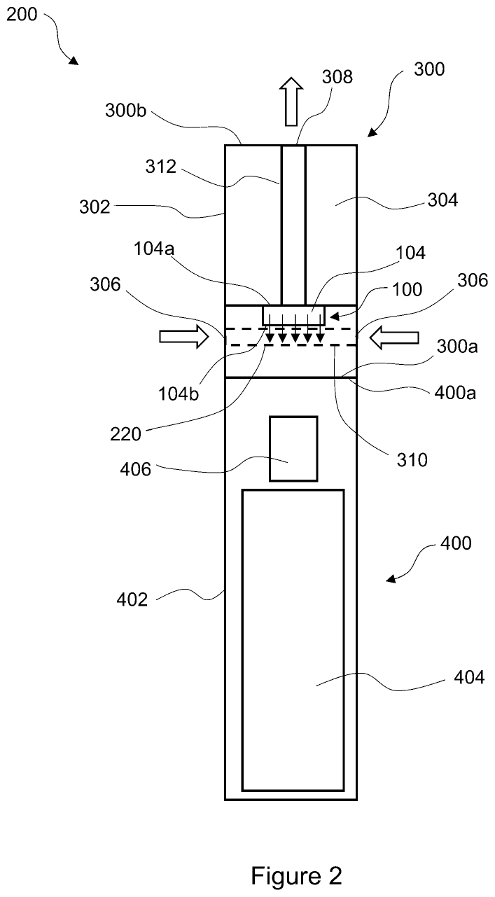

FIG. 2 shows a schematic longitudinal cross-sectional view of an aerosol-generating system according to an embodiment of the third aspect of the invention comprising the heater assembly of FIG. 1.

It will be appreciated that FIGS. 1 and 2 are schematic and have been simplified for the purposes of clarity. Consequently, some features may have been omitted and the features shown are not necessarily drawn to scale.

References to orientations such as vertical, horizontal, above, below, upper and lower, etc. when describing features shown in the figures are not intended to imply any limitation on the orientation of those features but are merely intended to show the relative spatial arrangement of the features. It will be appreciated that the features may have different orientations in use.

FIG. 1 shows a heater assembly according to an embodiment of the first aspect of the invention. The heater assembly 100 comprises a resistive heating element 102 for vaporising a liquid aerosol-generating substrate and a porous body 104 for conveying the liquid aerosol-generating substrate to the resistive heating element 102. The porous body 104 has a liquid absorption surface 104a and a heating surface 104b. The resistive heating element 102 is located on the heating surface 104b of the porous body 102.

The porous body 104 is an open-cell porous ceramic body. The porous body is formed from a suitable ceramic material, such as alumina. The porous body 104 includes a network of interconnected pores extending between the liquid absorption surface 104a and the heating surface 104b of the porous body 104. In the embodiment shown in FIG. 1, the porous body 104 is substantially cylindrical. The liquid absorption surface 104a and the heating surface 104b are end faces of the porous body 104. The porous body 104 has a curved surface 104c extending between the liquid absorption surface 104a and the heating surface 104b. A liquid impermeable coating is provided on the curved surface 104c of the porous body 104.

The resistive heating element 102 comprises a track arranged in a serpentine manner on the heating surface 104b of the porous body 104. Arrangement of the track in a serpentine manner allows fluid to pass between adjacent portions of the resistive heating element 102. The resistive heating element 102 comprises a silver palladium alloy consisting of 60 weight percent to 70 weight percent silver, 10 weight percent to 20 weight percent palladium, 1 weight percent to 5 weight percent carbon, 5 weight percent to 15 weight percent oxygen, and impurities. The resistive heating element 102 is deposited on the heating surface 104a of the porous ceramic body 104 using a suitable physical vapour deposition process, such as sputtering.

The heater assembly 100 further comprises electrical contacts (not shown) that are connected to the resistive heating element 102. The electrical contacts are arranged on the heating surface 104a of the porous body 104. The resistive heating element 102 extends between the electrical contacts. The electrical contacts are arranged to be connected to control circuitry for controlling the supply of electrical power to the resistive heating element 102. The electrical contacts are formed from a suitable material that is more electrically conductive material than the resistive heating element, such as copper, gold, silver, or zinc.

In FIG. 1, the liquid absorption surface 104a is shown as the lower surface of the porous body 102 in FIG. 3 and the heating surface 104b is shown as the upper surface of the porous body 104. However, it will be appreciated that the orientation of these surfaces may differ in use of the heater assembly 102 in an aerosol-generating system. As described further below, in use, liquid aerosol-generating substrate contacting the liquid absorption surface 104a of the porous body 104 is conveyed through the network of interconnected pores of the porous body 104 to the heating surface 104b of the porous body 104. The resistive heating element 102 located on the heating surface 104b of the porous body 104 heats the liquid aerosol-generating substrate conveyed to the heating surface 104b of the porous body 104. Aerosol-generating substrate vaporised by the resistive heating element 102 can pass between adjacent portions of the resistive heating element 102 and be emitted from the heating surface 104b of the porous body 104.

FIG. 2 shows a cross-sectional view of an aerosol-generating system 200 according to an embodiment of the third aspect of the invention. The aerosol-generating system comprises two main components, a cartridge 300 and an aerosol-generating device 400. The aerosol-generating system 200 is portable and has a size comparable to a conventional cigar or cigarette. The cartridge has a distal end 300a and a proximal end 300b. The distal end 300a of the cartridge 300 is removably coupled to the aerosol-generating device 400. A mouthpiece is arranged at a proximal end 300b of the cartridge 300.

The cartridge 300 comprises a cartridge housing 302 containing the heater assembly 100 shown in FIG. 1 and a liquid storage portion 304 for holding a liquid aerosol-generating 30 substrate. In FIG. 2 the orientation of the heater assembly 100 is inverted compared to FIG. 1 so that the liquid absorption surface 104a of the porous body 104 faces upwards and is in fluid communication with the liquid storage portion 304 and the heating surface 104b of the porous body 104 on which the resistive heating element 102 is located faces downwards. Liquid aerosol-generating substrate is conveyed downwards from the liquid absorption surface 104a through the porous body 104 to the resistive heating element 102 and vaporised aerosol-generating substrate is emitted from the heating surface 104b of the porous body 104 when electrical power is supplied to the resistive heating element 102.

The cartridge 300 comprises one or more air inlets 306 formed in the cartridge housing 302 at a location along the length of the cartridge 300. An aerosol outlet 308 is located in the mouthpiece at the proximal end 300b of the cartridge 300. The one or more air inlets 306 are in fluid communication with the aerosol outlet 308 to define an airflow pathway through the cartridge 300 of the aerosol-generating system 200. The airflow pathway flows from the one or more air inlets 306 to the heater assembly 100 in an airflow channel 310. The heater assembly 100 is arranged in fluid communication with the airflow pathway in the airflow channel 310. Air enters the one or more air inlets 306 and flows through the airflow channel past the heater assembly 100 in an average airflow direction.

In the embodiment shown in FIG. 2, the liquid storage portion 304 is annular in cross-section and is arranged around a central sealed aerosol channel 312. Once the airflow pathway reaches the heater assembly 100, it is diverted upwards around the sides of the heater assembly 100 and flows through the aerosol channel 312 to the aerosol outlet 308.

The distal end 300a of the cartridge 300 is removably coupled to a connection end 400a the aerosol-generating device 400. The distal end 300a of the cartridge 300 and the connection end 400a of the aerosol-generating device 400 each have electrical contacts or connections (not shown) that are arranged to cooperate to provide an electrical connection between the cartridge 300 and the aerosol-generating device 400.

The aerosol-generating device 400 comprises a device housing 402 that contains a power source 404, which in the embodiment shown is a rechargeable lithium ion battery, and control circuitry 406.

The aerosol-generating system 200 is configured so that a user can puff or draw on the mouthpiece at the proximal end 300b of the cartridge 300 to draw aerosol into their mouth through the aerosol outlet 312. In operation, when a user puffs on the mouthpiece, air is drawn in through the one or more air inlets 306, along the airflow pathway through the airflow channel 310, past and around the heater assembly 100 and along the airflow pathway through the aerosol channel 312 to the aerosol outlet 308. The control circuitry 406 controls the supply of electrical power from the power source 404 to the cartridge 300 when the aerosol-generating system 200 is activated. This in turn controls the amount and properties of the vapour produced by the heater assembly 100. The control circuitry 406 may include an airflow sensor (not shown) and the control circuitry 406 may supply electrical power to the heater assembly 100 when user puffs are detected by the airflow sensor. This type of control arrangement is well established in aerosol-generating systems such as inhalers and e-cigarettes. When a user puffs on the mouthpiece at the proximal end 300b of the cartridge 202, the heater assembly 100 is activated and generates a vapour that is entrained in the air drawn along the airflow pathway through the airflow channel 310. The vapour cools to form an aerosol, which is then drawn into the mouth of the user through the aerosol outlet 308.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention.

1. A heater assembly for an aerosol-generating system, the heater assembly comprising:
a resistive heating element for vaporising a liquid aerosol-generating substrate; and
a porous body for conveying the liquid aerosol-generating substrate to the resistive heating element, the porous body having a liquid absorption surface and a heating surface,
the resistive heating element being located on the heating surface of the porous body, wherein the resistive heating element comprises a silver palladium alloy consisting of 53 weight percent to 73 weight percent silver, 7 weight percent to 23 weight percent palladium, 1 weight percent to 7 weight percent carbon, 3 weight percent to 17 weight percent oxygen, and impurities.

2. The heater assembly according to claim 1 wherein the silver palladium alloy consists of 60 weight percent to 70 weight percent silver, 10 weight percent to 20 weight percent palladium, 1 weight percent to 5 weight percent carbon, 5 weight percent to 15 weight percent oxygen, and impurities.

3. The heater assembly according to claim 1 wherein the silver palladium alloy comprises less than 1 weight percent of impurities.

4. The heater assembly according to claim 1 wherein the resistive heating element has a resistance at 25 degrees Celsius of between 0.8 Ohms and 1.1 Ohms.

5. The heater assembly according to claim 1 wherein the resistive heating element has a temperature coefficient of resistance (TCR) of between 250 parts per million per degree Celsius and 450 parts per million per degree Celsius for a temperature range of 25 degrees Celsius to 300 degrees Celsius.

6. The heater assembly according to claim 1 wherein the resistive heating element is deposited on the heating surface of the porous body by physical vapor deposition or chemical vapor deposition.

7. The heater assembly according to claim 1 wherein the resistive heating element has a thickness of between 5 micrometres and 50 micrometres.

8. The heater assembly according to claim 1 wherein the resistive heating element comprises a track defining a path across the heating surface of the porous body.

9. The heater assembly according to claim 1 wherein the porous body has a porosity of between 40 percent and 70 percent.

10. The heater assembly according to claim 1 wherein the porous body has a median pore size of between 10 micrometres and 30 micrometres.

11. The heater assembly according to claim 1 wherein the porous body is a porous ceramic body.

12. The heater assembly according to claim 1 wherein the porous body comprises one or more of alumina, an aluminosilicate, a boride, silica, a silicide, silicon carbide, silicon nitride, and zirconia.

13. A cartridge for an aerosol-generating system, the cartridge comprising:
the heater assembly according to claim 12; and
a liquid storage portion for holding a liquid aerosol-generating substrate,
wherein the liquid storage portion is located proximate the liquid absorption surface of the porous body of the heater assembly.

14. An aerosol-generating system comprising:
the cartridge according to claim 13; and
an aerosol-generating device comprising a power supply for supplying power to the heater assembly of the cartridge and control circuitry for controlling the supply of power from the power supply to the heater assembly of the cartridge,
wherein the cartridge is removably couplable to the aerosol-generating device.
